(19) United States
(12) Patent Application Publication
(10) Pub. No.: US 2026/0198449 A1
(43) Pub. Date: Jul. 16, 2026

(54) MILKING SYSTEM HAVING A CENTRAL CLEANING UNIT

(71) Applicant: LELY PATENT N.V., Maassluis (NL)

(72) Inventors: Sander Christiaan FASE, Zoetermeer (NL); Nicky KOENEN, Zierikzee (NL); Dirk KRAAIJ, Delft (NL); Ruben WALINGA, 's-Gravenzande (NL)

(73) Assignee: LELY PATENT N.V., Maassluis (NL)

(21) Appl. No.: 19/129,831

(22) PCT Filed: Dec. 8, 2023
(86) PCT No.: PCT/IB2023/062406

§ 371 Date: May 14, 2025

(30) Foreign Application Priority Data
Dec. 19, 2022 (NL) 2033751

(51) Int. Cl. A01J 7/02; A01J 5/007

(52) U.S. Cl. CPC A01J 7/022; A01J 5/007

(57) ABSTRACT

A milking system with two or more milking devices and a central cleaning unit. The milking system also has a buffer unit, with two tanks, that receives and temporarily stores fluids. The buffer unit is connected to a bulk milk storage system through a milk transport system with a milk transport line. During a first cleaning stage, a first cleaning liquid runs through a cleaning liquid transport line to the milking devices, and a valve system allows the first cleaning liquid's first flow from one of the milking devices to be collected in the first buffer tank and a milk flow from the other milking device to the second buffer tank. During a second cleaning stage, the first cleaning liquid's second flow from the first buffer tank through the milk transport line cleans part of the milk transport system.

### BACKGROUND OF THE INVENTION

### Field of the Invention

The invention is related to a milking system having a central cleaning unit for cleaning the milk carrying parts of the system, in particular the milk transport line to the bulk milk storage tank.

### Description of the Related Art

Milking systems comprising milking devices for extracting milk from dairy animals, such as cows, goats and sheep, are known. In dairy farms, such milking systems use milking devices like milking robots and milking carrousels to (semi-)automatically milk cows. Each milking robot or milking carrousels can milk only a limited number of cows per day. With a herd that exceeds the maximum number of cows per milking device, an extra milking device is required. Bigger herds therefore require multiple milking devices. In addition, the required barn area will increase with bigger herds, which will increase the distance over which the extracted milk is to be transported, and this may affect the quality of the milk, especially on large dairy farms. The longer the transporting distance and time, the more likely that the quality of the milk decreases through for instance turbulent flow in the transport lines.

In known milking systems, one cleaning unit is available for each milking device or for each pair of milking devices and the associated milk lines, which may be shared by a pair of or more milking devices. In case of more than two milking devices, a cluster of cleaning units can be provided, wherein each cleaning unit is connected to a central control system that controls the cleaning units in the cluster. The central control system gives all the cleaning units in the cluster the central signal to clean all milking devices and the associated milk lines at the same time during a scheduled cleaning stage, as required for the hygiene of the milking system. During that cleaning stage, all milking devices will be in a cleaning mode and none of them is available for milking a dairy animal, i.e. the cleaning of the clusters is a synchronized cleaning of all milking devices. Because of the herd hierarchy and habits of each individual cow in the herd, even a temporary milking stop can be detrimental to the milk production. Moreover, the synchronization of the cleaning of all milking devices is disadvantageous in that all of the milking devices are released for milking when the control system marks all milking devices as having been cleaned. If the control system notices that at least one of the milking devices in the cluster is not ready, for instance because of an error in the cleaning stage, none of the other milking devices will be released for milking. Thus, it is not possible to keep on milking during the scheduled cleaning stage in the known milking systems as all milking devices in such milking systems will be in cleaning mode and thus unavailable for milking. Moreover, cleaning all milking devices requires a large volume of cleaning fluid, in particular water.

It would therefore be desirable to provide a stable floor that alleviates at least some of the perceived inconveniences of the prior art.

### BRIEF SUMMARY OF THE INVENTION

According to the invention, there is provided a milking system comprising:
two or more milking devices for extracting milk from a dairy animal;
a central cleaning unit for cleaning each of the milking devices and milk-carrying parts of the milking system, wherein the central cleaning unit comprises at least one cleaning liquid transporting line for transport of a first cleaning liquid, wherein each of the milking devices is in flow connection with the cleaning liquid transport line,
a buffer unit for receiving and temporarily storing fluids, the buffer unit comprising a first buffer tank, and a second buffer tank, wherein each of the buffer tanks is in flow connection with each of the milking devices through a respective milk line, and a valve system for regulating the flow of the milk to each of the buffer tanks, and
a control unit for controlling at least part of the milking system,
wherein the milking system further comprises a milk transport system with a milk transport line that connects the buffer unit with a bulk milk storage system, and
wherein during a first cleaning stage, the central cleaning unit is configured to supply the first cleaning liquid through the cleaning liquid transport line for cleaning one of a first milking device and a second milking device, and the valve system is configured to allow a first flow of first cleaning liquid from the first milking device or the second milking device to be collected in the first buffer tank and to allow a milk flow from the other of the second milking device and the first milking device to the second buffer tank; and wherein during a second cleaning stage, the first cleaning liquid in a second flow from the first buffer tank through the milk transport line cleans at least part of the milk transport system.

The two or more milking devices extract milk from a dairy animal, such as a cow, a nanny goat (female goat), a ewe (female sheep), a mare (female horse), camel or dromedary, jenny (female donkey) or any other animal from which milk can be extracted. The milking devices are especially suitable for cows, and are preferably executed as automatic milking device, such as a carrousel, but most preferably as an automatic milking robot, especially an automatic milking robot that enables free cow traffic in the animal barn. The milking device may comprise teat cups and a milk jar for collecting the milk of one milking. A milking is defined as the amount of milk extracted from a single dairy animal during a single visit of the milking device.

The central cleaning unit is part of a central utility system that provides a central infrastructure for the temporary storage of the extracted milk through the buffer unit and for the cleaning of the milk-carrying parts of the milking system, such as the milking device(s), the milk line and the buffer unit. For this, the central utility system comprises the central cleaning unit. Through its various parts, the central utility system is connected with each of the milking devices, for instance via the milk line with the buffer unit and via the cleaning liquid transport line with the central cleaning unit. The central utility system may comprise additional units that can be centralized in the milking system, i.e. that can be clustered instead of being provided with each milking device or with each group of milking devices if the milking system comprises two or more groups of milking devices, such as the buffer unit. The central cleaning unit may comprise one or more cleaning liquid tanks.

The cleaning liquid transport line connects each milking device with the central cleaning unit. The central cleaning unit provides the cleaning liquid via the cleaning liquid transport line to the milking devices. During cleaning the milking devices, the cleaning liquid is taken from the cleaning liquid transport line. This is also the case if a milking device must be cleaned again unexpectedly, for instance due to a malfunction or a separation cleaning.

Several types of cleaning of the milking device can occur during use. During an incidental cleaning, only one of the milking devices undergoes a local cleaning. After the local cleaning, the cleaning liquid flows to a discharge without going through the milk line, as only the milk carrying parts of the milking device are cleaned. Such incidental cleanings happen for instance during start-up of the one milking device, after a standstill for a longer period, or after separation of bad milk, usually called a separation cleaning. On the contrary, the first and second cleaning stages constitute the main cleaning of the milk carrying parts of the milking device and the milk-carrying parts of the central utility system. The first cleaning stage is a scheduled cleaning of all the milking devices in the milking system. During the first cleaning stage, each milking device and the associated milk line that connects the milking device with the buffer unit, is individually cleaned. The cleaning liquid may be a gas or a liquid, for instance water, e.g. tap water, or a diluted chemical solution. The second cleaning stage is a scheduled cleaning of other milk carrying parts of the milking system, in particular the first buffer tank and the milk transport line.

Irrespective of the sort of cleaning, the milking device will be in cleaning mode and will request cleaning liquid from the cleaning unit during a cleaning. That milking device will not be available for the extraction of milk in the cleaning mode. As the local cleaning is incidental and for one milking device at a time, the other milking devices can keep on milking the dairy animal(s). In the known art, during a cleaning stage, all milking devices are in cleaning mode at the same time. In contrast, the central utility system of the invention allows the milking system to have at least one milking device, and preferably more than one milking device in case of more than two milking devices, available for milking during the cleaning stage where each milking device and associated milk line is individually cleaned. In other words, the central cleaning unit is configured such that during the cleaning stage milking devices are cleaned and available for milking in parallel. It is possible to have multiple milking devices and associated milk lines in cleaning mode at the same time, or at least partly overlapping times because of such individual cleaning, and in addition have at least one or multiple milking devices available for milking a dairy animal, i.e. in operational or milking mode.

Preferably, the cleaning unit comprises at least a first cleaning liquid container, wherein the cleaning liquid transport line comprises a first circuit line that is connected with the first cleaning liquid container. The circuit line allows the cleaning liquid to circulate and/or to be available for a prolonged time to the milking devices.

In a further embodiment, the cleaning unit comprises a second cleaning liquid container, and the cleaning liquid transport line comprises a second circuit line that is fluidly connected to the second cleaning liquid container, wherein the first cleaning liquid container contains a first cleaning liquid, and the second cleaning liquid container contains a second cleaning liquid. The first and the second cleaning liquid may differ in temperature, pressure and/or composition, for example hot versus cold or tepid, pressurized versus atmospheric, or water versus diluted chemical solution.

The cleaning unit may further comprise a third cleaning liquid container fluidly connected to each of the first and second circuit line, wherein the third cleaning liquid container comprises a third cleaning liquid. The third cleaning liquid may differ from the first and second cleaning liquids in temperature, pressure and/or composition.

The first and/or the second circuit line can comprise a supply line and a return line, wherein the supply line supplies the cleaning liquid up to a connecting line with each of the milking devices, and wherein the return line returns at least part of the cleaning liquid to the respective cleaning liquid container if that part of the cleaning liquid remains unused. The cleaning liquid circulates in the circuit line, of which a part functions as a supply line, supplying the cleaning liquid to the milking devices, and another part functions as a return line that returns the remainder of the cleaning liquid in the circuit line to the respective cleaning liquid container. The cleaning liquid can be drawn from the supply line via the connecting line that connects the circuit line to the milking device. For this a valve or valve unit may be provided at an end of the connecting line that connects to the milking device. During a cleaning, the milking device can draw cleaning liquid from the first or second circuit line via the supply line.

The buffer unit comprises a first buffer tank and a second buffer tank. In some cases more than two buffer tanks can be provided. Each buffer tank is in flow connection with each of the milking devices, i.e. each of the buffer tanks is configured to receive milk from the milking devices via the milk line. A valve system regulates the flow of the milk to each of the buffer tanks, e.g. the valve system controls the flow rate of the milk to each buffer tank, which can be zero, i.e. there is no flow of milk to one or more of the buffer tanks.

The control unit controls at least part of the milking system, for instance the buffer unit and the cleaning unit. Optionally, a further control unit can be provided to control other parts of the milking system, such as a central vacuum unit, see further below. It is preferred that the control unit and the further control unit have a connection to exchange data. Additionally, the bulk milk storage device does not need to be controlled by the control system of milking system system, but can be controlled by separate control system that preferably has a connection to exchange data, signals and commands with the control unit(s) used to control the milking system. The milking system may further comprise the bulk milk storage system for storing the extracted milk. The bulk milk storage system may comprises one or more bulk milk tanks. The bulk milk tank may be a stationary bulk milk tank or a movable bulk milk tank provided on a truck. The bulk milk storage system may comprise multiple bulk milk tanks and a circuit line, which circuit line connects each of the bulk milk tanks with the milk transport system. The bulk milk storage system may further comprise a further central cleaning unit for cleaning the circuit line and/or the one or more bulk milk tanks. The central cleaning unit will then clean the milk transport line up to the circuit line.

In the first cleaning stage, the first cleaning liquid from the central cleaning unit is supplied through the cleaning liquid transport line to one of a first milking device and a second milking device for cleaning that milking device. The valve system allows a first flow of first cleaning liquid from the first milking device or the second milking device to be collected in the first buffer tank and allows a milk flow from the other of the second milking device and the first milking device to the second buffer tank. In other words, the valve system controls the flow of the first cleaning liquid and the milk such that they are separately collected in the first buffer tank and the second buffer tank, respectively. In the second cleaning stage, the first cleaning liquid is used to clean at least part of the milk transport system by flowing from the first buffer tank through the milk transport line.

During the first cleaning stage, each of the milking devices and respective milk lines are cleaned individually. The first buffer tank collects the first cleaning liquid from the first milking device that is being cleaned, and the second buffer tank collects milk from the second milking device that is available for extraction of milk from dairy animals. During the second cleaning stage the milk transport system is cleaned with the first cleaning liquid collected in the first buffer tank.

According an embodiment, during an operational stage, the valve system is configured to allow the milk flow from each of the first milking device and the second milking device to the first buffer tank. In other words, all of the milk milked by the milking devices may be directed to the one single buffer tank to be collected.

It may be advantageous to collect the milk in a single buffer tank in the operational stage as well, such that the other buffer tank is ready for collection of first cleaning liquid when the first cleaning stage is started for the milking system.

In an embodiment, the milking system comprises at least three milking devices, wherein at any time during the first cleaning stage the valve system is configured to allow a milk flow from at least one of the at least three milking devices to the second buffer tank.

During the first cleaning stage and/or the operational stage a milk flow with a continuous flow may be allowed from the second buffer tank to the bulk milk storage system. The flow rate of the milk flowing to the bulk milk storage can be constant, or can be adjusted on the basis of the amount of milk received by the respective buffer tank.

It is preferred that during the second cleaning stage the milk flow from the second buffer tank ceases, and the milk transport line is emptied by the central cleaning unit with a third flow of a cleaning fluid. The first cleaning liquid can be water, hot, cold or tepid, and with or without chemicals added. The cleaning fluid can be a pressurized fluid or gas, such as pressurized air. The cleaning fluid can be applied right before the second cleaning stage to empty the milk transport line. Alternatively or additionally, the cleaning fluid can be used to empty the milk transport line after the milk transport line has been cleaned during the second cleaning stage. When in both cases pressurized air is used, the steps of emptying the milk transport line is called ‘blow-empty’. The cleaning fluid can be supplied from a cleaning fluid tank that is either comprised in the cleaning unit, or separately provided within the milking system.

Preferably, the second cleaning stage is subsequent to the first cleaning stage. The first and second cleaning stage may have an offset starting time, for the second cleaning stage is performed with the collected first cleaning liquid in the first buffer tank. The second cleaning stage may not start before a sufficient amount of first cleaning liquid is collected in the first buffer tank or not even before the first cleaning stage is finished. In particular, the first and second cleaning stage partly overlap. The operational stage may start when the first cleaning stage has finished, i.e. when all milking devices have been cleaned during the first cleaning stage. The operational stage may partly overlap with the second cleaning stage.

According to an embodiment, the central cleaning unit is configured to use the first cleaning liquid collected in the first buffer tank, during the second cleaning stage. Preferably, the central cleaning unit comprises at least one cleaning liquid tank and a liquid transport line connected to the buffer unit, and the first buffer tank has in flow connection with the cleaning liquid tank, and wherein the first cleaning liquid is recirculated through the cleaning liquid tank for reheating to a predetermined temperature, wherein the first cleaning liquid is subsequently transported via the liquid transport line to the first buffer tank for use in the second cleaning stage.

The first cleaning liquid may be recirculated via the central cleaning unit such that is reheated for use in the second cleaning stage. The recirculation may start while the first cleaning stage is still in process, preferably, the recirculation starts after completion of the first cleaning stage. The first cleaning liquid is transported from the first buffer tank to the cleaning liquid tank via a retour line system that is in flow connection with each buffer tank and the cleaning liquid tank, and subsequently reheated to a predetermined temperature.

During the second cleaning stage, the first buffer tank may be cleaned in addition to the bulk milk transport line.

It is preferred that each of the buffer tanks has a volume that is at least equal to the volume of milk that all milking devices in the milking system extract in a predetermined time period. In particular, the predetermined time period may range from the duration of the second or first cleaning stage, whichever is shorter, to the total duration of the first cleaning stage and the second cleaning stage added up, i.e. the time from the very first start of the first cleaning stage to the very end of the second cleaning stage. Preferably, the predetermined time period is equal to or longer than the first and/or second cleaning stage.

According to an embodiment, the buffer unit comprises a first and a second buffer line connected to the respective buffer tank, and the valve system comprises a first valve unit between a first milking device and the buffer lines, and a second valve unit between a second milking device and the buffer lines, wherein in a first mode the first valve unit provides a first flow connection between the first milking device and the first buffer tank via the first buffer line, and in a second mode the first valve unit provides a second flow connection between the first milking device and the second buffer tank via the second buffer line, and the second valve unit providing the first and second flow connections between the second milking device and the respective first and second buffer tanks via the respective buffer lines.

Each of the buffer tanks may be provided with a buffer line to be in flow connection with each of the milking devices. The valve system controlling the flow of fluid, e.g. milk or a cleaning fluid, may comprise at least a valve unit for each buffer line, provided between the respective milk line and buffer line. As such, the valve system may comprise at minimum a number of valve units equal to the number of buffer lines, preferably two, and at maximum a number of valve units equal to the number of milking devices in the milking system. In the minimum case, and for each case where the number of valve units is less than the number of milking devices in the milking system, clusters of at least two milking devices may be connected to a single valve unit. In the maximum case, the number of valve units may be equal to the number of milking devices in the milking system, and each valve unit may be provided between a milking device and the buffer lines. Preferably, every valve unit comprises at least two valves, in particular three valves. Each valve unit may be construed from multiple valves, such that each connected pipeline or other milk carrying line can be served by the valve unit. A valve unit having three valves may be used for a so-called block-bleed-block arrangement, which has the advantage of a bleed or drain in between the closed valves so that in case of a failing valve, the fluid is drained from the valve unit.

Preferably, during the first cleaning stage the first valve unit for the first milking device is in the first mode such that the first cleaning liquid is collected in the first buffer tank, and wherein for the second milking device the second valve unit is in the second mode such that extracted milk is collected in the second buffer tank.

In particular, in the first mode a first valve of the first valve unit opens the first flow connection between a first milk line of the first milking device and the first buffer tank, and a second valve of the first valve unit closes the second flow connection to the second buffer tank. With this arrangement, fluid flowing from the first milking device is directed to the first buffer tank, while the connection between the first milking device and the second buffer tank is blocked.

Moreover, in the second mode a first valve of the second valve unit may close the first flow connection between a second milk line of the second milking device and the first buffer tank and a second valve of the second valve unit may open the second flow connection between the second milk line and the second buffer tank. In this arrangement, fluid flowing from the second milking device is directed to the second buffer tank, while the connection between the second milking device and the first buffer tank is blocked.

In an embodiment, a valve device is provided between the buffer lines and the central cleaning unit, and wherein in a first state of the valve device the central cleaning unit and the first buffer line are in flow connection, and wherein in a second state of the valve device the central cleaning unit and the second buffer line are in flow connection. The valve device can control the flow of the cleaning liquid from the cleaning unit that may pass through the buffer lines. Preferably, the valve device comprises a number of valves at least equal to the number of cleaning liquid tanks and/or buffer lines. According to an embodiment, the milking system comprises a filter device for filtering the extracted milk. It is advantageous to filter the milk before it reaches the bulk milk tank. The filter device may remove any lumps, dirt and the like from the milk.

Furthermore, the milking system may comprise a cooling device for cooling the extracted milk. The filter device and/or the cooling device are preferably provided downstream from the buffer unit in the milk transport line.

Preferably, at least one milk pump is provided in the milk transport line between the buffer unit and the bulk milk storage system. In particular, one pump per buffer tank may be provided, preferably directly downstream from the buffer tank. An additional booster milk pump may be provided downstream from the buffer unit in the milk transport line.

The milking system may further comprise a central vacuum system to provide a continuous vacuum to each of the milking devices, and wherein the central vacuum system is connected to each of the milking devices to provide each milking device individually of vacuum for milking a dairy animal. Preferably, the vacuum system comprises a vacuum unit with at least two vacuum pumps, and a vacuum line, wherein the vacuum line connects the vacuum unit with each of the milking devices. The vacuum pumps may be connected in parallel. The vacuum system may be comprised in the central utility system.

Alternatively, each of the milking devices may be provided with a vacuum pump for providing a vacuum in the milking device.

The central vacuum system allows for a central and energy efficient provision of vacuum to the milking devices to extract milk from the dairy animal, but also a stable vacuum. In known milking systems, usually two milking devices share one vacuum pump. When the vacuum in one of the milking devices is not properly working, for instance due to a malfunctioning valve, the one shared vacuum pump has not enough capacity to provide the other milking device with the required vacuum level. In that case, neither of the two milking devices will be available to extract milk. According to the invention, using a central vacuum system will at least overcome the described situation, as only the milking device having issues with the vacuum valve will be affected.

### BRIEF DESCRIPTION OF THE FIGURES

FIG. 1 shows a schematic representation of a first embodiment of the milking system according to the invention.

FIG. 2 shows a schematic representation of a further embodiment of the milking system according to the invention.

### DETAILED DESCRIPTION OF THE INVENTION

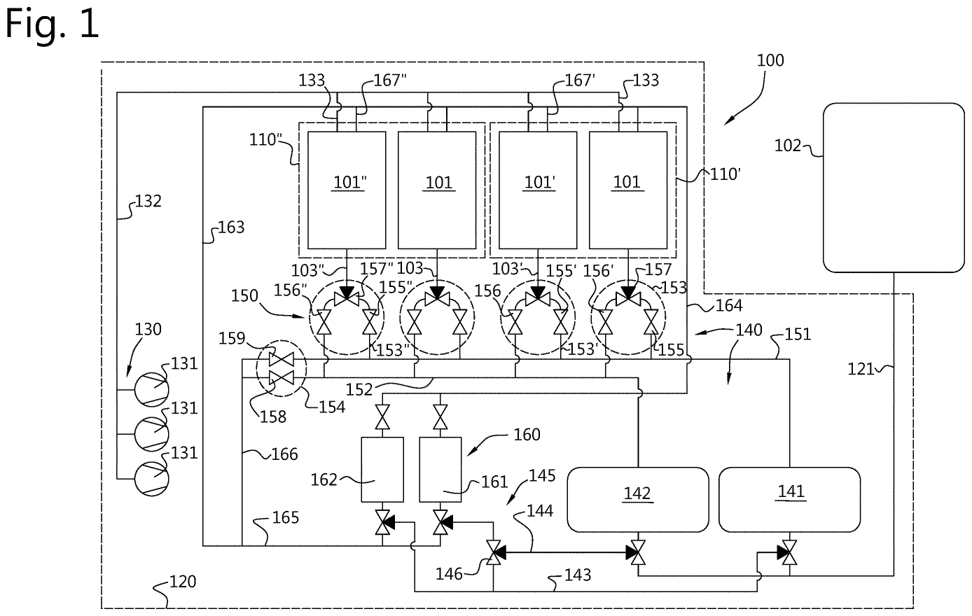

FIG. 1 shows a schematic representation of a milking system 100 comprising four milking devices 101, displayed as two groups 110′ and 110″ of milking devices 101. The milking devices 101 extract milk from dairy animals 107, in particular cows, and are preferred to be automatic milking robots, preferably stimulating free cow traffic in the barn. The milking system 100 further comprises a control unit (not shown), a buffer unit 140 for the temporary storage of extracted milk, and a milk transport line 121 for transporting milk to a bulk milk storage system. Furthermore, the milking system 100 comprises a central cleaning unit 160 for cleaning the milk-carrying parts of the milking system 100, such as the milking devices 101, the milk lines 103, the buffer unit 140, and the milk transport line 121. The bulk milk storage system comprising a bulk milk tank 102 may form part of the milking system 100.

Vacuum is centrally provided to the milking devices 101 by a central vacuum system 130 with a vacuum unit 134 comprising three vacuum pumps 131. The vacuum unit 134 is connected with each of the milking devices 101 through a vacuum line 132 with individual vacuum connecting lines 133 that branch of to the individual milking devices 101. Since the vacuum is centrally provided, the milking devices 101 in the milking system 100 do not contain a vacuum pump.

The cleaning unit 160 in FIG. 1 comprises two cleaning liquid containers 161, 162, and one cleaning liquid transport line 165 that connects the cleaning liquid containers 161, 162 with each of the milking devices 101. The cleaning unit 160 can thus supply cleaning liquid to each of the milking devices 101 individually.

The cleaning liquid transport line 165 is a circuit line with a supply line 163 from the cleaning liquid containers 161, 162 to the connections with the milking devices 101, and a discharge line 164 from these connections to the cleaning liquid containers 161, 162. With the circuit line 165 the cleaning liquid can be continuously available, for instance during a first cleaning stage.

The buffer unit 140 comprises a first buffer tank 141 and a second buffer tank 142, and a first buffer line 151 and a second buffer line 152, connected to the respective buffer tank. For each milking device 101, a valve unit 153 is provided. All valve units 153 together with a valve device 154 form a valve system 150. Each valve unit 153 is provided in the respective milk line 103 that guides the extracted milk from the milking device 101 to the buffer unit 140.

Each milking device 101 obtains milk from a dairy animal 107, for example a cow, during milking operation, and the obtained milk of each obtained milking during the milking operation will be guided via the associated milk line 103, the respective valve unit 153 and one of the buffer lines 151, 152 to the respective buffer tank 141, 142 for temporary storage. The milk is transported from the buffer tank 141, 142 to the bulk milk tank 102 via the milk transport line 121 with a continuous flow. At the same time, milk flows from one or more milking devices 101 to the buffer tank 141, 142 as long as the respective milking devices are extracting milk from the dairy animal 107. As such, there is no start or stop effect in the milk flow, while the milk remains in motion. Additionally, the milk flow rate in the milk transport line can be kept relatively low such that mechanical loading of the milk is prevented and the milk quality can be kept.

Alternatively, an intermediate scheme of filling and emptying can be adapted. In this case, the buffer tank 141, 142 is to be filled with milk to a certain level (not the maximum level of the buffer tank) and then emptied to a certain level (not the lowest level or level 0 in the buffer tank). This causes a peak loading for the respective pumps, but also for the milk, which is disadvantageous for the milk quality.

The advantage of the use of the two buffer tanks 141, 142 is that if something happens in the milk transport line 121 or in the buffer unit 140 itself, this does not affect the milking devices, since the milk is being collected in the buffer tank 141, 142. It is preferred that under normal conditions, i.e. there are no errors or defects in the milking system, the milk is collected in only one buffer tank 141, 142 at a time.

The central cleaning unit 160, the buffer unit 140, the vacuum system 130, the valve system 150 and their associated parts and devices, form a central utility system 120 (excluding the groups 110′, 110″ of milking devices 101). The central utility system 120 may comprise other devices or elements described herein as well, such as the control unit.

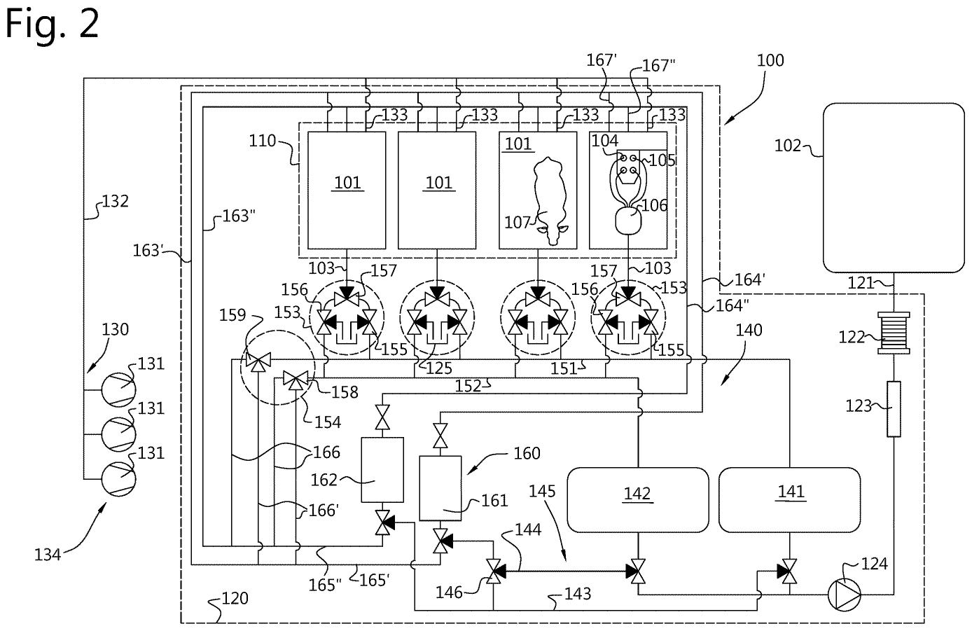

In the embodiment of FIG. 1, the vacuum system 130 is part of the central utility system 120, and is controlled by the control unit of the central utility system 120. In the embodiment shown in FIG. 2, the vacuum system 130 is part of the milking system 100, functioning independently of the central utility system 120. The vacuum system 130 is then controlled by a separate control unit (not shown). The control unit of the central utility system 120 and the control unit of the vacuum system 130 may be connected such that they can communicate with each other.

FIG. 2 shows that a milking device 101 comprises four teat cups 104 and a milk jar 106 for collecting the milk of one milking. The volume of the milk jar 106 may be equivalent to a maximum expected milking of the dairy animal 107, e.g. a cow. The milk jar 106 has a direct and a flow connection to the teat cups 104. After each milking of a cow 107, the milk jar 106 is emptied towards the buffer unit. Each buffer tank 141, 142 of the buffer unit may have a volume between 1000 and 2000 liters, which would constitute tens if not hundreds of milkings from the dairy animals 107. Preferably, the buffer tanks have equivalent volumes.

Turning to FIG. 1, during the first cleaning stage, a first valve unit 153′ for a first milking device 101′ is in a first situation wherein a first valve 155′ of the first valve unit 153′ opens a first flow connection between a first milk line 103′ of the first milking device 101′ and the first buffer tank 141, i.e. the first valve 155′ is in an open position, and a second valve 156′ of the first valve unit 153′ closes a second flow connection to the second buffer tank 142, i.e. the second valve 156′ is in a closed position, such that cleaning liquid is collected in the first buffer tank 141. In addition, it is prevented that cleaning liquid can come in contact with the milk. For a second milking device 101″ a second valve unit 153″ is in a second situation wherein a first valve 155″ of the second valve unit closes the first flow connection between a second milk line 103″ of the second milking device 101″ and the first buffer tank 141, and a second valve 156″ opens the second flow connection between the second milk line 103″ and the second buffer tank 142, such that extracted milk is collected in the second buffer tank 142. In FIG. 2, the first and second valves 155, 156 have a third situation, wherein the flow connection to the respective buffer line is closed, but the third valve directs a flow to the respective valve anyway. In that case, the flow can be discharged to a drain 125.

The valve units 153 comprises a third valve 157, that is provided to direct the milk from the milking device 101 to either the first valve 155 or the second valve 156. It also provides a block-bleed-block configuration of the valve unit 153. The number of valves in the valve unit 153 depends on the number of buffer tanks 141, 142 to be cleaned in the central utility system 120, and thus on the number of buffer lines 151, 152.

In a subsequent first cleaning stage, the roles of the first and second buffer tanks 141, 142 may be reversed, such that the first buffer tank 141 is then used for the collection of milk, and the second buffer tank 142 is used to collect cleaning liquid from the cleaned milking devices 101.

The cleaning liquid collected during the first cleaning stage in one of the buffer tanks 141, 142 is subsequently used to clean the buffer tank, the associated buffer line 151, 152, and the milk transport line 121 to the bulk milk tank 102 during a second cleaning stage. During the second cleaning stage, the first cleaning liquid cleans at least part of the milk transport system in a second flow from the first buffer tank through the milk transport line.

The central cleaning unit 160 comprises a first cleaning liquid tank 161, a second cleaning liquid tank 162 in flow connection to the buffer unit via a retour line system 145. The retour line system 145 comprises a first retour line 143 connecting the first buffer tank 141 with the cleaning liquid tanks 161, 162, a second retour line 144 connecting the second buffer tank 142 with the cleaning liquid tanks 161, 162, and a retour line valve 146 to direct the first cleaning liquid flowing from one of the buffer tanks to either the first or the second cleaning liquid tanks 161, 162. With a suitable valve configuration, the retour line system 145 may comprise a single retour line.

In the first cleaning stage, when the first cleaning liquid is being collected in the first buffer tank 141, the first cleaning liquid is recirculated through the first cleaning liquid tank 161 for reheating to a predetermined temperature via the first retour line 143 and the retour line valve 146 in a first position. The first position of the retour line valve 146 opens a flow connection between the first buffer tank 141 and the first cleaning liquid tank 161, while closing a flow connection with the second cleaning liquid tank 162. After reheating in the first cleaning liquid tank 161, the first cleaning liquid is transported via the liquid transport line 166 and the first buffer line 151 to the first buffer tank 141 for use in the second cleaning stage.

The second cleaning stage may comprise a rinsing step where at least the milk transport line 121 is rinsed with cold water. Before this step, the milk transport line 121 may be emptied using a cleaning fluid, e.g. a pressurized gas to blow the milk transport line empty.

The valve device 154 shown in FIG. 1 comprises two device valves 158, 159 that are connected to one of the buffer lines 151, 152. During the first cleaning stage, preferably after all of the milking devices are cleaned, a first device valve 159 is in a first state and opens up to the first buffer line 151, thus providing a third flow connection between the first buffer line 151 and the cleaning unit 160. A second device valve 158 is then in a second state, and closes the third flow connection between the second buffer line 152 and the cleaning unit 160, as this second buffer line 152 is used to transport milk to the second buffer tank 142. The second state of the valve device 154 can also be used outside of the first cleaning stage, i.e. when not in the first cleaning stage but in operational stage, both device valves 158, 159 of the valve device 154 are in the second state and close the third flow connection with the respective buffer lines 151, 152.

FIG. 2 shows a second embodiment of the milking system 100. FIG. 2 shows the vacuum system 130 as a separate part of the milking system 100 next to the central utility system 120. Furthermore, the cleaning unit 160 comprises a first circuit line 165′ and a second circuit line 165″. The first cleaning liquid container 161 comprises a first cleaning liquid that circulates in the first circuit line 165′, and the second cleaning liquid container 162 comprises a third cleaning liquid that circulates in the second circuit line 165″. Circulating the cleaning liquid in the circuit line 165 can be limited to the first cleaning stage, but preferably at least one cleaning liquid circulates permanently in one of the circuit lines 165 to facilitate separation cleanings.

Additionally, FIG. 2 shows a milk pump 124, a cooling device 122 and a filter device 123 that are provided in the milk transport line 121. The milk pump 124 is provided between the buffer unit 140 and the bulk milk tank 102. The milk pump 124 allows the milk to be transported over longer distances without mechanically loading, and thus reducing the quality of the milk. The cooling device 122 is provided for cooling of the milk before it enters the bulk milk tank 102. The cooling device 122 in FIG. 2 is configured as a heat exchanger, but any suitable cooling device can be used for this purpose. Moreover, the milking system 100 in FIG. 2 comprises a filter device 123 for filtering the milk. The cooling device 122 and the filter device 123 are both provided in the milk transport line downstream from the buffer unit 140.

### LIST OF PARTS

| | |
|---|---|
| 100. | Milking system |
| 101. | Milking device |
| 102. | Bulk milk tank |
| 103. | Milk line |
| 104. | Teat cup |
| 105. | Milk hose |
| 106. | Milk jar |
| 110. | Group of milking devices |
| 120. | Central utility system |
| 121. | Milk transport line |
| 122. | Cooling device |
| 123. | Filter device |
| 124. | Milk pump |
| 125. | Drain |
| 130. | Vacuum system |
| 131. | Vacuum pump |
| 132. | Vacuum line |
| 133. | Vacuum connection line |
| 134. | Vacuum unit |
| 140. | Buffer unit |
| 141. | First buffer tank |
| 142. | Second buffer tank |
| 143. | First retour line |
| 144. | Second retour line |
| 145. | Retour line system |
| 146. | Retour line valve |
| 150. | Valve system |
| 151. | First buffer line |
| 152. | Second buffer line |
| 153. | Valve unit |
| 154. | Valve device |
| 155. | First valve of valve unit |
| 156. | Second valve of valve unit |
| 157. | Third valve of valve unit |
| 158. | First valve of valve device |
| 159. | Second valve of valve device |
| 160. | Cleaning unit |
| 161. | First cleaning liquid container |
| 162. | Second cleaning liquid container |
| 163. | Supply line |
| 164. | Discharge line |
| 165. | Circuit line |
| 166. | Liquid transport line |
| 167. | Connecting line |

1. A milking system comprising:
two or more milking devices for extracting milk from a dairy animal;
a central cleaning unit for cleaning each of the milking devices and milk-carrying parts of the milking system, wherein the central cleaning unit comprises at least one cleaning liquid transporting line for transport of a first cleaning liquid, wherein each of the milking devices is in flow connection with a liquid transport line;
a buffer unit for receiving and temporarily storing fluids, the buffer unit comprising a first buffer tank, and a second buffer tank, wherein each of the buffer tanks is in flow connection with each of the milking devices through a respective milk line, and a valve system for regulating the flow of the milk to each of the buffer tanks;
a control unit for controlling at least part of the milking system and
a milk transport system with a milk transport line that connects the buffer unit with a bulk milk storage system, and
wherein during a first cleaning stage, the central cleaning unit is configured to supply the first cleaning liquid through the liquid transport line for cleaning one of a first milking device and a second milking device, and the valve system is configured to allow a first flow of first cleaning liquid from the first milking device or the second milking device to be collected in the first buffer tank and to allow a milk flow from the other of the second milking device and the first milking device to the second buffer tank; and
wherein during a second cleaning stage, the first cleaning liquid in a second flow from the first buffer tank through the milk transport line cleans at least part of the milk transport system.

2. The milking system according to claim 1, wherein during an operational stage, the valve system is configured to allow the milk flow from each of the first milking device and the second milking device to the first buffer tank.

3. The milking system according to claim 2, comprising at least three milking devices, wherein at any time during the first cleaning stage the valve system is configured to allow a milk flow from at least one of the at least three milking devices to the second buffer tank.

4. The milking system according to claim 2, wherein during the first cleaning stage and/or the operational stage a milk flow with a continuous flow is allowed from the second buffer tank to the bulk milk storage system.

5. The milking system according to claim 3, wherein during the second cleaning stage the milk flow from the second buffer tank ceases, and the milk transport line is emptied by the central cleaning unit with a third flow of a cleaning fluid.

6. The milking system according to claim 1, wherein the second cleaning stage is subsequent to the first cleaning stage.

7. The milking system according to any of claim 1, wherein the first and second cleaning stage partly overlap.

8. The milking system according to claim 1, wherein the first cleaning liquid comprises water, and wherein the central cleaning unit is configured to use the first cleaning liquid collected in the first buffer tank, during the second cleaning stage.

9. The milking system according to claim 8, wherein the central cleaning unit comprises at least one cleaning liquid tank and a liquid transport line connected to the buffer unit, and the first buffer tank is in flow connection to the cleaning liquid tank, and wherein the first cleaning liquid is recirculated through the cleaning liquid tank for reheating to a predetermined temperature, wherein the first cleaning liquid is subsequently transported via the liquid transport line to the first buffer tank for use in the second cleaning stage.

10. The milking system according to claim 1, wherein the liquid transport line comprises a first circuit line that fluidly connects a first cleaning liquid container and each of the milking devices, and wherein the first cleaning liquid container comprises the first cleaning liquid.

11. The milking system according to claim 10, wherein the cleaning unit comprises a second cleaning liquid container and wherein the cleaning liquid transport line comprises a second circuit line that is fluidly connected to the second cleaning liquid container, and wherein the second cleaning liquid container comprises a third cleaning liquid.

12. The milking system according to 11, wherein the cleaning unit comprises a third cleaning liquid container fluidly connected to each of the first and the second circuit line, wherein the third cleaning liquid container comprises a fourth cleaning fluid.

13. The milking system according to claim 12, wherein the first and/or second circuit line comprises a supply line and a return line, wherein the supply line supplies the respective cleaning liquid up to a connecting line with each of the milking devices, and wherein the return line returns at least part of the respective cleaning liquid to the respective cleaning liquid container if that part of the cleaning liquid remains unused.

14. The milking system according to claim 1, wherein each of the buffer tanks has a volume that is at least equal or larger than a volume of milk that all milking devices in the milking system extract in a predetermined time period.

15. The milking system according to claim 14, wherein the predetermined time period is equal to or longer than the first and/or second cleaning stage.

16. The milking system according to claim 1, wherein at least one milk pump is provided in the milk transport line between the buffer unit and the bulk milk storage system.

17. The milking system according to claim 1, wherein the buffer unit comprises a first and a second buffer line connected to the respective buffer tank, and the valve system comprises a first valve unit between the first milking device and the buffer lines, and a second valve unit between the second milking device and the buffer lines, wherein in a first mode the first valve unit provides a first flow connection between the first milking device and the first buffer tank via the first buffer line, and in a second mode the first valve unit provides a second flow connection between the first milking device and the second buffer tank via the second buffer line, and the second valve unit providing the first and second flow connections between the second milking device and the respective first and second buffer tanks via the respective buffer lines.

18. The milking system according to claim 17, wherein a number of valve units is equal to a number of milking devices in the milking system, and wherein each valve unit is provided between a milking device and the buffer lines.

19. The milking system according to claim 18, wherein during the first cleaning stage the first valve unit for the first milking device is in the first mode such that the first cleaning liquid is collected in the first buffer tank, and wherein for the second milking device the second valve unit is in the second mode such that extracted milk is collected in the second buffer tank.

20. The milking system according to any claim 17, wherein in the first mode a first valve of the first valve unit opens the first flow connection between a first milk line of the first milking device and the first buffer tank, and a second valve of the first valve unit closes the second flow connection to the second buffer tank.

21. The milking system according claim 20, wherein in the second mode a first valve of the second valve unit closes the first flow connection between a second milk line of the second milking device and the first buffer tank and a second valve of the second valve unit opens the second flow connection between the second milk line and the second buffer tank.

22. The milking system according to claim 21, wherein a valve device is provided between the buffer lines and the central cleaning unit, and wherein in a first state of the valve device the central cleaning unit and the first buffer line are in flow connection, and wherein in a second state of the valve device the central cleaning unit and the second buffer line are in flow connection.

23. The milking system according to claim 22, wherein the central cleaning unit comprises one or more cleaning liquid tanks, and the valve device comprises a number of valves at least equal to the number of cleaning liquid tanks and/or buffer lines.
